(19) United States
(12) Patent Application Publication
(10) Pub. No.: US 2013/0282437 A1
(43) Pub. Date: Oct. 24, 2013

(54) SYSTEM AND METHOD FOR PROVIDING CONSUMER PREFERENCE AND INTENTION DATA TO MERCHANTS

(71) Applicants: Alan Cooke, Dublin (IE); Stephen Paul Hendrix, Saint Charles, MO (US); Michael Henry Fiore, Ridgefield, CT (US); Ana Carolina de Macedo Martins, Barueri (BR); Sinead Fitzgerald, Kildare (IE); Thomas Buckley, Dublin (IE); Kathy Koh Ming-Li, Singapore (SG)

(72) Inventors: Alan Cooke, Dublin (IE); Stephen Paul Hendrix, Saint Charles, MO (US); Michael Henry Fiore, Ridgefield, CT (US); Ana Carolina de Macedo Martins, Barueri (BR); Sinead Fitzgerald, Kildare (IE); Thomas Buckley, Dublin (IE); Kathy Koh Ming-Li, Singapore (SG)

(21) Appl. No.: 13/864,875

(22) Filed: Apr. 17, 2013

Related U.S. Application Data
(60) Provisional application No. 61/635,102, filed on Apr. 18, 2012.

(51) Int. Cl. G06Q 30/02

(52) U.S. Cl. CPC G06Q 30/0202
USPC 705/7.31

(57) ABSTRACT

Methods and apparatus for providing purchase intention and consumer preference data to merchants are described. In an embodiment, the process includes receiving, by a server computer from a device at a merchant location, consumer check-in data and then retrieving consumer preferences data and purchase history data. The method also includes retrieving merchant data indicative of items and/or services offered by the merchant, and determining purchase intention data indicative of an item or service that the consumer intends to purchase based on at least one of the consumer preferences data, the consumer purchase history data, and the merchant data. The process then includes transmitting the purchase intention data in real-time to a merchant device at the merchant location.

### CROSS REFERENCE TO RELATED APPLICATION(S)

This application claims the benefit of U.S. Provisional Patent Application No. 61/635,102 filed on Apr. 18, 2012, the contents of which are hereby incorporated by reference for all purposes.

### BACKGROUND

Consumer check-in technologies that function with internet-enabled mobile devices, such as Foursquare, are known. Such applications provide the ability for a consumer to use his or her Smartphone, for example, to provide information concerning his or her location when arriving at a merchant store, for example, and to obtain information concerning other people who may be at that store or close by. In some implementations, the consumer may be able to determine if any possible offers, such as discounts, are available from one or more merchants. For example, a consumer may enter a local coffee shop and check-in to his or her account by selecting a “Check-in” icon on the display screen of his or her mobile telephone to see if there are any discount offers available, and to receive information if any of his or her friends are present. In some cases, merchants who subscribe to such check-in services are given access to a dashboard interface which they can view on a personal computer display screen, for example, which allows them to view consumer data and/or consumer metrics. Merchants can utilize such data to create offers and/or deals to encourage consumers to shop in their retail locations. However, such check-in services do not provide a mechanism for consumers to provide and/or to push information or data to merchants in real-time concerning preferences and/or intentions.

The term “preference” relates to an attribute for a given consumer that the consumer wishes to share with a given set of merchants. For example, a consumer may indicate a preference for “Non-Dairy” products or for “Dark Chocolate”, or may specify food allergies such as a “Peanut allergy”. Preferences may also be generic, for example, the consumer prefers pasta instead of potatoes as a side dish, or may be specific to certain categories of merchant(s), or may be specific to particular merchants.

The term “intentions” relates to the reason or reasons that a consumer has arrived at a given merchant location (such as a retail store) and may include what the consumer wishes to achieve. For example, an intention may specify that the consumer is in a rush due to a later scheduled appointment, or could specify that the consumer is doing routine shopping, or that the consumer is shopping for a gift which may indicate that he or she would like some help to make a selection.

The inventors have recognized that there is a need for a system, apparatus and processes to facilitate check-in by consumers arriving at a merchant location, and to provide information in real-time to the merchants concerning those consumers relating to the consumers' preferences and/or purchasing intentions.

### BRIEF DESCRIPTION OF THE DRAWINGS

Features and advantages of some embodiments, and the manner in which the same are accomplished, will become more readily apparent with reference to the following detailed description taken in conjunction with the accompanying drawings, which illustrate exemplary embodiments (not necessarily drawn to scale), wherein:

FIG. 1 illustrates a consumer preference and intention data system according to an embodiment of the invention;

FIG. 2 is a screen shot of a “My Preferences” web page that may be accessed by a consumer during a registration process according to an embodiment of the invention;

FIG. 3 is a screen shot of a consumer notification information web page that may be provided for display on a merchant device according to an embodiment of the invention;

FIG. 4 is a screen shot of a “Merchant Dashboard” web page that may be provided for display on a merchant device and that includes several charts providing consumer information that may be helpful to a merchant according to an embodiment of the invention;

FIG. 5 is a block diagram of an embodiment of a Genie Server computer according to an embodiment of the invention; and

FIG. 6 is a flowchart illustrating a consumer intentions and preferences process according to an embodiment of the invention.

### DETAILED DESCRIPTION

In general, and for the purpose of introducing concepts of novel embodiments described herein, provided are systems, apparatus and methods for obtaining, by a merchant, intention and/or preference information of a consumer who has entered the merchant's location (such as a retail store). In some implementations both consumers and merchants must register to utilize a “Genie” system by utilizing a graphical user interface to provide information at a “Genie” website. The system is referred to herein as the “Genie” system because it grants the wish of merchants to know relevant information in real-time of the purchasing intentions of customers who have entered their retail stores.

The Genie system may obtain consumer preference data during a registration process, for example, from consumers who utilize a graphical user interface on a web page of a website provided for gathering such data. A Genie server computer may be configured to utilize that data entered by a consumer and to process additional consumer data obtained, for example, from a purchasing history database to determine customer intention data. The customer preference and purchasing intention data is then transmitted to a merchant device in real-time shortly after the consumer has checked-in at the merchant store so that the merchant may provide superior customer service. In some embodiments, merchants may be charged a nominal fee for receiving the intention and/or preference data, and the cost may be based on the amount of data provided during a specific period of time (for example, “X” amount of data in gigabytes per month may be included for a flat fee, but “X+1” gigabytes of data per month may cost a merchant an extra ten cents per gigabyte). In addition, a Genie mobile application may, in some embodiments, be offered free to consumers to utilize with their mobile devices (such as with a Smartphone) to encourage use. The Genie mobile application may include, in some embodiments, a game aspect wherein “points” or “badges” are awarded to a consumer based on frequency of check-ins or some other metric. In some implementations the customer may be able to redeem points and/or badges for discount certificates and/or monetary amounts from one or more merchants.

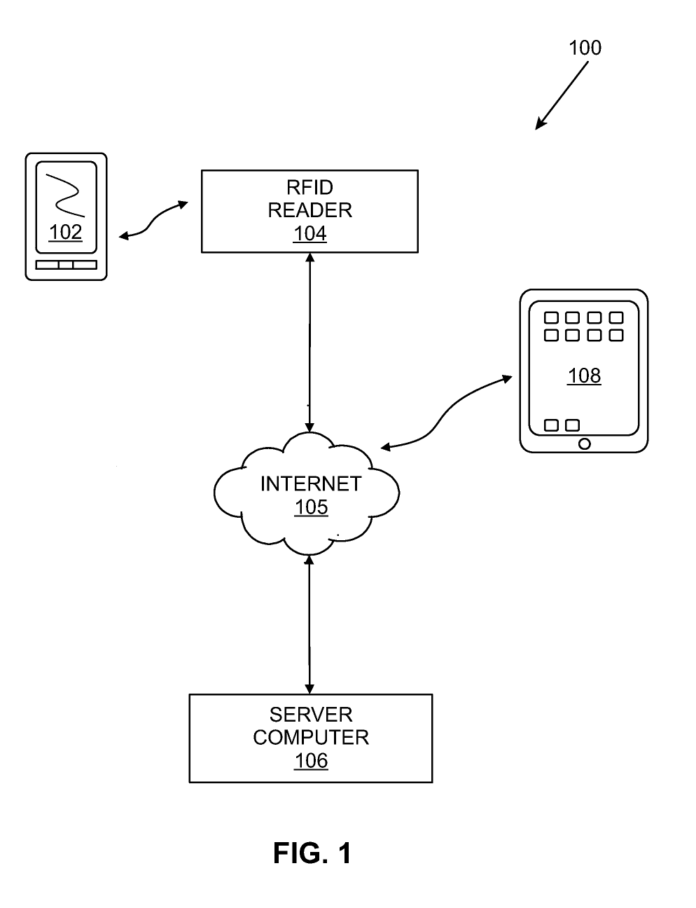

FIG. 1 illustrates an embodiment of a consumer preference and intention data system 100. In an implementation, a consumer who owns a payment enabled mobile telephone 102 and has registered as a Genie user checks-in at a merchant location by bringing the contactless payment-enabled device 102 into contact with, or close to, a reader device 104 of the merchant. Consumer data, such as the Primary Account Number (PAN), is read from the payment enabled mobile telephone and transmitted to a Server Computer 106 via the Internet 105. In some embodiments, the Server Computer utilizes the PAN to look-up consumer preference data (which has been specified by the consumer at the Genie website) and to access consumer purchase history data, which may be available in one or more databases. The Server Computer may also process the retrieved data to determine consumer intention data, for example, by inferring that the consumer intends to purchase a particular type of product from the merchant based on purchases that have occurred earlier that same day. The Server computer 106 then transmits one or more of the consumer preference data, consumer purchase history data and the consumer intention data via the Internet 105 to a computing device 108 of the merchant, which may be an iPad™, iPhone™ or Smartphone, for example, located in the merchant location. The merchant can then utilize the consumer preferences and intention information to, for example, have a salesperson greet the consumer and offer specific merchandise to the customer in the merchant's store and/or to provide loyalty points which can be tracked and/or saved by the Genie system for later use by the consumer (for example, the Genie Server computer may store loyalty points in a loyalty points database and provide an indication of the amount of points to be displayed on the Genie web page associated with the consumer).

It should be understood that the consumer may utilize other types of payment-enabled devices with the Genie system, such as a proximity payment card (such as a “PayPass®” proximity payment card offered by MasterCard International Incorporated, the assignee hereof), a payment-enabled personal digital assistant (PDA) device, a laptop computer, a tablet computer, or other mobile or handheld payment-enabled portable devices. Such payment-enabled devices typically include radio frequency identification (RFID) integrated circuits (IC) to provide interoperability between the contactless payment devices and proximity readers, such as the RFID reader 104 of FIG. 1. In some implementations, the merchant reader device 104 reads track-one data from a payment enabled device of the consumer and then transmits that track-one data via the Internet 105 to the Server Computer 106 which utilizes it to continue processing as explained above.

In some embodiments, the Server Computer 106 may also be operable to retrieve Twitter™ status update data and/or a Facebook™ status update data and/or other social network data which may have been entered by the customer and/or associates of the customer and that is related to the shopping activities of the consumer. For example, the consumer may use his or her Twitter™ account to tweet a message recommending a particular product that he or she just purchased in a retail store. Furthermore, the Server Computer may be configured to analyze the Twitter™ and/or a Facebook™ and/or other social network data, for example by utilizing natural language processing, to determine if at least one change has been recently made to at least one of the consumer's preferences or intentions. If so, the recently changed or updated consumer preferences and/or consumer intentions can be transmitted to the merchant's device so that the merchant may modify a particular merchandise offer, if appropriate.

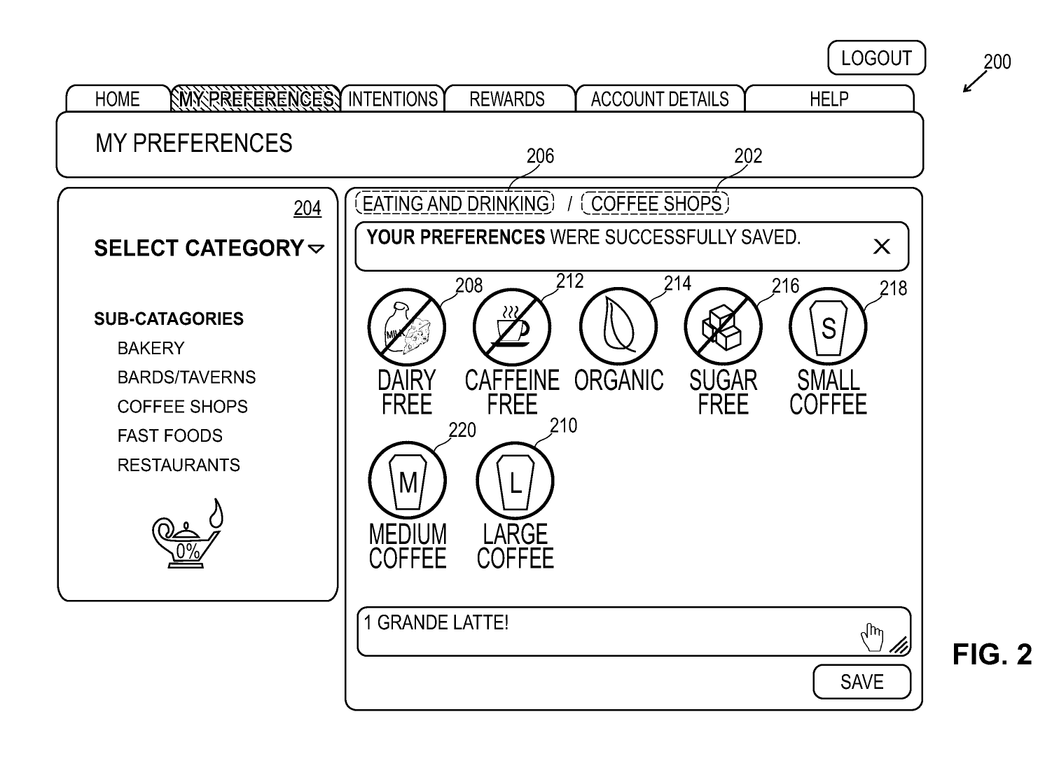

FIG. 2 is a screen shot of a “My Preferences” web page 200 that may be accessed by a consumer during a registration process (or after registration to enter updates) to provide preference data to the Genie system. In this example, the consumer has selected “Coffee Shops” 202 from an establishments sub-category list 204 called “Eating and Drinking” 206. As shown, the consumer indicated that he or she prefers “Dairy Free” 208 and “Large Coffee” 210 size drinks. In this example, the consumer could also have selected one or more of Caffeine Free 212, Organic 214, Sugar free 216, and a small coffee size 218 or a medium coffee size 220. Of course, in some other embodiments fewer or more such preference icons could be provided for selection by a consumer, and in some implementations it may be possible for the consumer to add one or more personal preferences to the list of available preferences.

After registering with the Genie system and entering preferences, the consumer enters a merchant location and checks-in, for example, by scanning a QR Code (Quick Response Code), or by tapping an NFC (Near-Field Communications) capable Smartphone against an NFC Tag in the merchant's location, and/or by tapping a MasterCard PayPass® card at an NFC-enabled smart poster, for example. As explained above, upon completion of the check-in process, the merchant is notified in real-time via an Internet connected device (for example, via an iPad™, iPhone™, other type of Smartphone, or any other electronic device capable of viewing a webpage) that the consumer is present and in a manner that includes information concerning the consumer and his or her preferences and/or purchasing intentions.

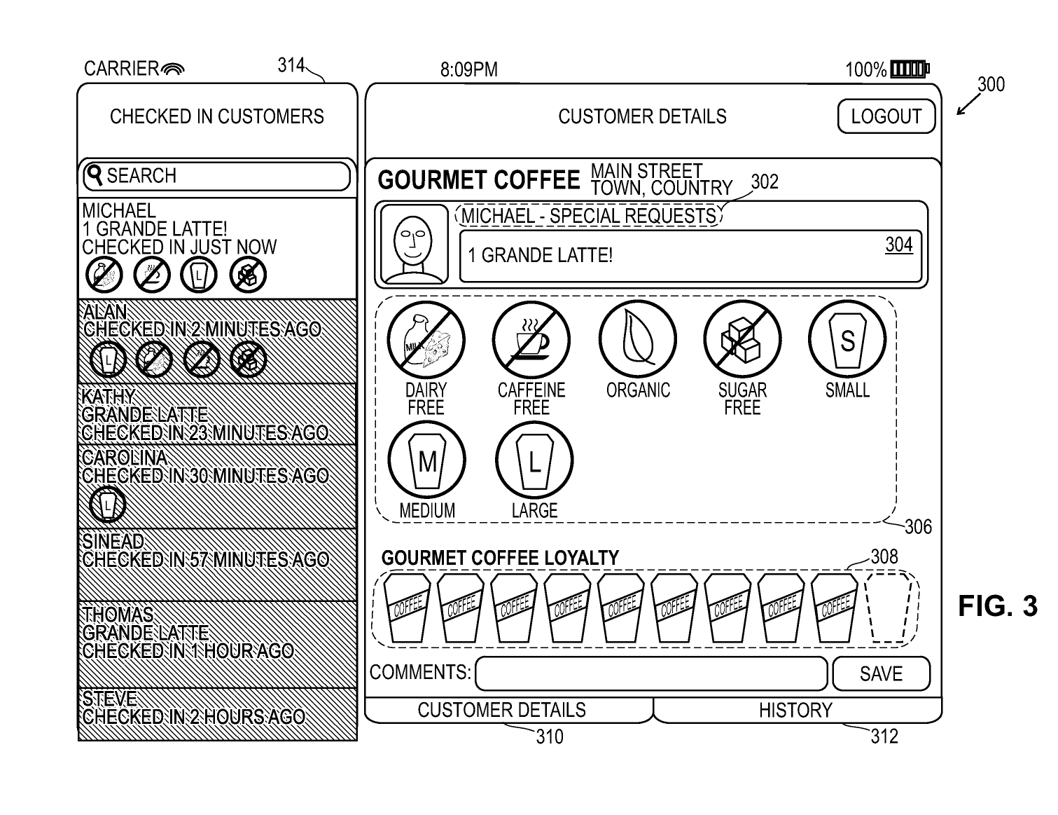

FIG. 3 illustrates a screen shot example of a consumer notification information web page 300 that may be transmitted to the merchant who, in this example, owns the “Gourmet Coffee” store. In this example, the information is formatted for display on the merchant's iPad™ device and is presented for a consumer named “Michael” 302 (including a photograph of the consumer). An intention or “special request” area 304 displays the message “1 grande latte” which indicates the consumer's intention or reason for visiting the Gourmet Coffee shop, and shown in area 306 are that consumer's preferences (which he previously registered on the Genie website). Also shown near the bottom of the screen is a row of “Gourmet Coffee Loyalty” cup icons 308 indicating that this customer has purchased nine (9) cups of coffee from the merchant over time and needs just one more cup of coffee to qualify for a free latte. At the bottom of the screen are a customer details button 310 (which may provide access to, for example, another web page to display the full name and residence address, billing address, and/or business address of the customer) and a customer history button 312 (which may provide access to another web page to display a record of past check-ins and data associated with items purchased during those check-ins, if applicable). In some embodiments, these buttons (and possibly other types of radio buttons or icons) may be provided for selection by the merchant to obtain further customer information.

Referring again to FIG. 3, the left side of the iPad™ screen includes a scrolling area 314 that lists other customers who have recently checked-in at the merchant location, some of which may still be in the store while others may have left. In some embodiments, the blocks that indicate “active” check-ins (customers still physically present in the merchant store) may be highlighted or be of another, bright color so that the merchant has an indication of who is still in his establishment and may be willing to purchase further items. These blocks may also be selectable by the merchant, so that when pressed by a finger of the merchant information related to that particular consumer is displayed on the screen. In addition, the blocks may include an indication of when a particular consumer checked-in, for example, by including a phrase such as “checked-in 23 minutes ago”. In some cases, it may be possible for the merchant to discern that one or more of the “active” check-ins would purchase an additional cup of coffee if offered a discount, which could be transmitted to the active check-in customers in real-time, for example, via a text message transmitted to their mobile telephones.

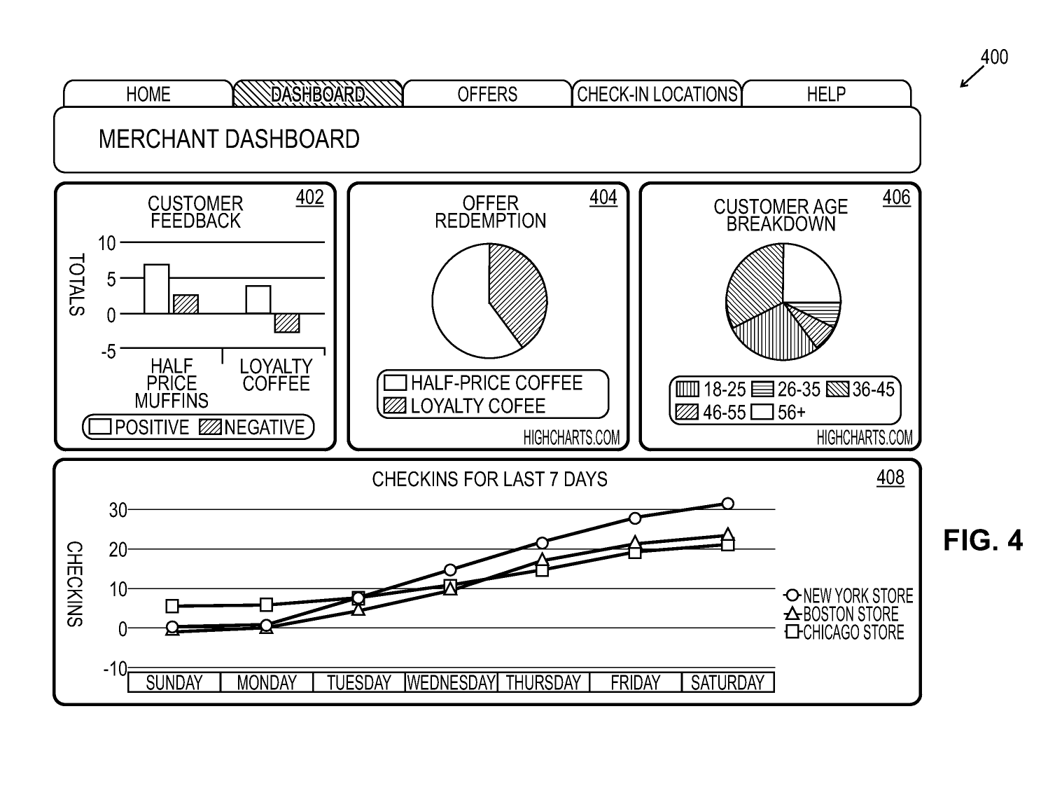

FIG. 4 is a screen shot example of a “Merchant Dashboard” web page 400 that includes several charts that provide information that may be helpful to the merchant. In particular, a customer feedback graph 402 indicates that a “half-price muffins” promotion was more popular than a “Loyalty Coffee” promotion (at least for customers who responded). Also shown are an “Offer Promotion” pie chart 404, a customer age breakdown pie chart 406, and a Check-ins for the last 7 days chart 408 for the New York, Boston and Chicago stores of the merchants. Such metrics may be helpful to the merchant with regard to planning future promotions. For example, the merchant may decide that Loyalty offers seem to work best at the New York retail location, and thus a “free coffee for every 10 purchased” promotion could be implemented in New York, whereas in Boston “half-price muffins” draw more customers into the store. In some embodiments, such offers can be emailed to consumers in New York and in Boston, or may be pushed to the Genie website pages of the consumers in those cities. In some implementations, an SMS or text message may also be transmitted to the Smartphones, for example, of the Genie consumers in real-time who have checked-in to the New York and/or Boston stores within the last two weeks (or some other time period) announcing the latest promotions which may be redeemed at the next check-in. The mobile devices utilized by consumers may also be capable of displaying a list of current promotions from two or more merchants that were recently received and that may be redeemed by the customer at the next check-in.

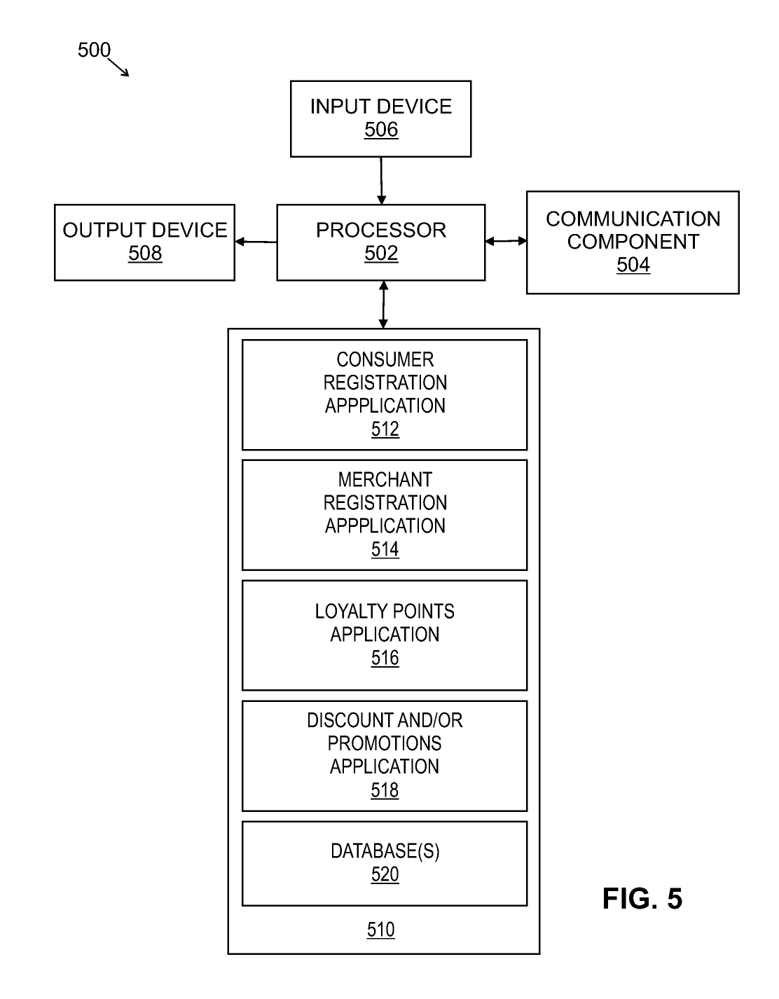

FIG. 5 is a block diagram of an embodiment of a Genie Server computer 500. The Genie Server computer may be conventional in its hardware aspects but may be controlled by software to cause it to operate in accordance with aspects of the methods presented herein. In particular, the Genie Server computer 500 may include a computer processor 502 operatively coupled to a communication component 504, an input device 506, an output device 508, and a storage device 510.

The computer processor 502 may constitute one or more conventional processors. Processor 502 operates to execute processor-executable steps, contained in program instructions described herein, so as to control the Genie Server computer 500 to provide desired functionality.

Communication component 504 may be used to facilitate communication with, for example, other devices (such as for receiving data from an RFID reader of a merchant and for transmitting data to an iPad™ tablet computer of the merchant). Communication device 504 may also, for example, have capabilities for engaging in data communications over conventional computer-to-computer data networks. Such data communications may be in digital form and/or in analog form.

Input device 506 may comprise one or more of any type of peripheral device typically used to input data into a computer. For example, the input device 506 may include a keyboard and a mouse and/or a touchpad that may be used, for example, by a systems engineer or other personnel authorized to, for example, perform Genie server computer system maintenance or other task. The output device 508 may comprise, for example, a display and/or a printer.

Storage device 510 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as so-called flash memory devices. Any one or more of the listed storage devices may be referred to as a “memory”, “storage” or a “storage medium”.

Storage device 510 stores one or more programs for controlling processor 502. The programs comprise program instructions that contain processor-executable process steps of the Genie Server computer 500, including, in some cases, process steps that constitute processes provided in accordance with principles of the processes presented herein.

The programs may include a consumer registration application 512 that manages a process by which consumers register themselves and/or their payment-enabled mobile devices, for example, with the Genie Server computer 500. In some embodiments, the Genie consumer account registration process may allow the consumers to register themselves with the Genie Server computer 500 by accessing, for example via their mobile telephone or tablet computer, a suitable web page hosted by the Genie Server computer 500. The information gathered from the consumer (financial account holder) during the registration process may include the consumer's name, a primary payment card account number (PAN), and mobile telephone number (or other mobile device identifier). The consumer registration process may also require the consumer to select one or more preferences from a list provided to the consumer that may be related to specific products or services offered by merchants who have also registered with the Genie system, and may request that the consumer provide information regarding membership in one or more social networking websites and/or business networking websites (such as, for example, Facebook™ at Facebook.com and/or Twitter™ at Twitter.com and/or LinkedIn™ at Linkedin.com). A Genie merchant registration application 514 may also be included, which allows merchants to self-register by accessing a Genie merchant web page and providing required information. For example, merchants may be required to select to receive one or more levels or types of consumer information, which may cost varying amounts of money that may depend on the type and/or amount of data to be provided. Details concerning the Genie account registration process for consumers and merchants have been provided elsewhere herein.

The storage device 510 may also store applications 516 and 518 for controlling the Genie Server computer 500 to provide for, respectively, awarding loyalty points and for providing consumers with discounts and/or promotions information. In addition, the storage device 510 may include one or more databases 520 that are maintained by the Genie Server computer 500 on the storage device 510. Among these databases may be, for example, a consumer database and a merchant database.

The application programs of the Genie Server computer 500, as described above, may be combined in some embodiments, as convenient, into one, two or more application programs. Moreover, the storage device 510 may store other programs or applications, such as one or more operating systems, device drivers, database management software, web hosting software, and the like.

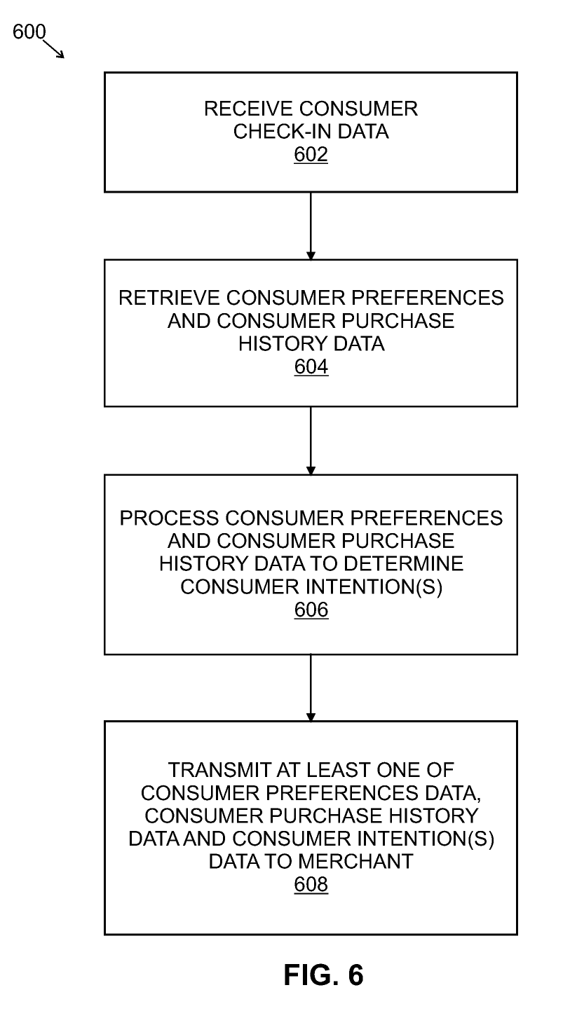

FIG. 6 is a flowchart illustrating a consumer preferences and purchase intention(s) process 600 according to an embodiment. A Genie server computer receives 602 consumer check-in data, which has been read by an RFID reader, for example, at the merchant's store location. The Genie server computer retrieves 604 the consumer's preferences and purchasing history data, and then processes that data to determine 606 one or more consumer purchasing intentions. Lastly, the Genie server computer transmits 608 the consumer preferences data, the consumer's purchasing history and an implied purchasing intention to the merchant. The merchant may then access, for example, a consumer check-ins graphical user interface on his iPad™ to view the information associated with that consumer so as to provide excellent customer service and hopefully sell products to the consumer.

Thus, in accordance with the above descriptions, a consumer can use a mobile payment device (such as a payment-enabled Smartphone and/or a PayPass® card) to carry out a check-in operation without carrying out a purchase transaction. When using a PayPass® card, in an implementation Track 1 data is read from the card and transmitted to a service which translates this information to the appropriate profile and completes the check-in on the consumer's behalf. Next, preferences and implied intentions of that consumer are pushed to a merchant by virtue of the check-in action. The implied intentions may be determined by using previous purchase history data. For example, if a consumer purchases item “X” and then checks-in at a store that provides logical and complimentary goods and services, then an inferred customer intention can be discerned and pushed to the merchant with this information. For example, a consumer checks-in to a department store of a first merchant and buys an expensive brown suit and then next checks-in at a nearby shoe store of a second merchant. Based on that consumer's previous purchase patterns and the previous transaction in the department store, an implied goal can be derived and transmitted to the second merchant along with the information concerning the purchase of the expensive brown suit. In some embodiments, the Genie system may have access to product information, including details of style and color of shoes with can be transmitted to the second merchant. These details may enable the shoe store merchant to instruct a store salesman, for example, to offer to help the consumer find a pair of shoes that would match the suit. Thus, in this example, the shoe store merchant would know that the consumer is likely coming to his merchant location to buy shoes to go with the new suit.

Accordingly, through use of the Genie system, the merchant has an opportunity to react to both the preferences and intentions of the consumers and thus to provide a superior level of service. In addition, through use of the Genie system the Genie mobile application has the ability to provide opportunities to the consumer to obtain offers and coupons from merchants in real-time that are highly relevant to the consumer and that may be based on the consumers' needs.

As the term “payment transaction” is used herein and in the appended claims, it should be understood to include the types of transactions commonly referred to as “purchase transactions” in connection with payment card systems.

As used herein and in the appended claims, the term “initiating a transaction” includes a proximity payment device such as a payment-enabled mobile telephone communicating with reader device that may be associated with a POS terminal. The term “initiating a transaction” can also include a payment-enabled mobile device communicating with a website to transmit and receive data so as to enter into on-line payment transactions.

The above descriptions and illustrations of processes herein should not be considered to imply a fixed order for performing the process steps. Rather, the process steps may be performed in any order that is practicable, including simultaneous performance of at least some steps.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
receiving, by a server computer from a device at a merchant location, check-in data of a consumer;
retrieving, by the server computer based on the consumer check-in data, consumer preferences data and consumer purchase history data;
retrieving merchant data indicative of items and services offered by a merchant associated with the merchant device;
determining, by the server computer, purchase intention data indicative of at least one item or service that the consumer intends to purchase based on at least one of the consumer preferences data, the consumer purchase history data, and the merchant data; and
transmitting, by the server computer in real-time to a merchant device at the merchant location, the purchase intention data.

2. The method of claim 1, further comprising, transmitting, by the server computer in real-time to the merchant device, at least one of the consumer's preference data, the consumer's awards data, the consumer's purchase history data, and consumer details data.

3. The method of claim 2, further comprising charging a fee to the merchant for providing at least one of the purchase intention data, the consumer's preference data, the consumer's awards data, the consumer's purchase history data, and consumer details data.

4. The method of claim 3, wherein the fee is calculated based on an amount of consumer data provided to the merchant within a predetermined period of time.

5. The method of claim 1, wherein the check-in data of the consumer comprises at least one of a primary account number (PAN), track-one data, a consumer identifier, and a mobile telephone number of the consumer.

6. The method of claim 1, wherein the merchant device comprises at least one of a personal computer, a laptop computer, a tablet computer, and a smartphone.

7. The method of claim 1, wherein the consumer utilizes a consumer mobile device to provide the check-in data at the merchant location.

8. The method of claim 7, wherein the consumer mobile device comprises at least one of a proximity payment card, a mobile telephone, a payment-enabled personal digital assistant (PDA) device, a laptop computer, or a tablet computer.

9. The method of claim 1, further comprising:
retrieving, by the server computer based on the check-in data, social network update data related to the consumer;
determining, based on the social network update data that at least one of a consumer preference has changed or that the consumer indicated a purchase intention; and
transmitting, by the server computer, at least one of the consumer preference change and the consumer intention to the merchant device in real-time.

10. The method of claim 9, wherein the social network update data comprises at least one of a Twitter™ status update, a Facebook™ status update, and a LinkedIn™ status update.

11. The method of claim 1, further comprising, prior to receiving the check-in data of the consumer:
receiving, by the server computer, registration data from the consumer, the registration data including consumer preference data and mobile device data;
transmitting, by the server computer to the mobile device of the consumer, a mobile application that includes a game aspect;
subsequent to receiving consumer check-in data, awarding points to the consumer; and
storing, by the server computer, the points associated with the consumer.

12. The method of claim 11, wherein the points are consumer loyalty points awarded based on at least one of a frequency of check-ins at the merchant location and an amount of money spent at the merchant location.

13. The method of claim 1, further comprising providing an indication to the merchant device of consumers who are present in the merchant location including an indication of an amount of time that elapsed since each consumer provided check-in data.

14. The method of claim 1, further comprising:
providing, by the server computer, a merchant dashboard webpage accessible by the merchant device that displays business analytics data comprising at least one of consumer data and offer data;
receiving from the merchant device a request to promulgate at least one merchant promotional offer to select customers of the merchant; and
providing, by the server computer, the at least one merchant promotional offer to the select customers of the merchant.

15. The method of claim 14, wherein the consumer data comprises at least one of customer feedback data, customer age breakdown data and customer check-in data.

16. The method of claim 14, wherein the offer data comprises at least one of a rebate offer, a discount offer, and redemption data.

17. The method of claim 14, wherein the server computer provides the merchant promotional offer to the select customers by at least one of transmitting an SMS message to each customer device of the select customers, transmitting a text message to each customer device of the select customers, transmitting an e-mail message to e-mail accounts of the select customers, and pushing an indication of the promotional offer to an offer webpage accessible to the select customers.

18. An apparatus comprising:
a processor;
a communication component operably connected to the processor; and
a storage device operably connected to the processor and storing instructions configured to cause the processor to:
receive from a device at a merchant location, check-in data of a consumer;
retrieve, based on the consumer check-in data, consumer preferences data and consumer purchase history data;
retrieve merchant data indicative of the goods and services offered by a merchant associated with the merchant device;
determine purchase intention data indicative of an item or service that the consumer intends to purchase based on at least one of the consumer preferences data, the consumer purchase history data, and the merchant data; and
transmit in real-time the purchase intention data to a merchant device at the merchant location.

19. The apparatus of claim 18, wherein the storage device further comprises instructions configured to cause the processor to transmit in real-time to the merchant device, at least one of the consumer's preference data, the consumer's awards data, the consumer's purchase history data, and consumer details data.

20. The apparatus of claim 19, wherein the storage device further comprises instructions configured to cause the processor to charge a fee to the merchant for providing at least one of the purchase intention data, the consumer's preference data, the consumer's awards data, the consumer's purchase history data, and consumer details data.

21. The apparatus of claim 18, wherein the storage device further comprises instructions configured to cause the processor to:
retrieve, based on the check-in data, social network update data related to the consumer;
determine based on the social network update data that at least one of a consumer preference has changed or that a consumer indicated a purchase intention; and
transmit at least one of the consumer preference change and the consumer intention to the merchant device in real-time.

22. The apparatus of claim 18, wherein the storage device further comprises instructions configured to cause the processor to:
provide a merchant dashboard webpage accessible by the merchant device that displays business analytics data comprising at least one of consumer data and offer data;
receive from the merchant device a request to promulgate at least one merchant promotional offer to select customers of the merchant; and
provide the at least one merchant promotional offer to the select customers of the merchant.

23. The apparatus of claim 18, wherein the storage device further comprises instructions configured to cause the processor to provide an indication to the merchant device of consumers who are present in the merchant location including an indication of an amount of time that elapsed since each consumer provided check-in data.

24. The apparatus of claim 18, wherein the storage device further comprises instructions configured to cause the processor to, prior to receiving the check-in data of the consumer:
receive registration data from the consumer, the registration data including consumer preference data and mobile device data;
transmit to the mobile device of the consumer, a mobile application that includes a game aspect;
subsequent to receiving the check-in data of the consumer, award points to the consumer; and
store the points associated with the consumer.
